(19) United States
(12) Patent Application Publication
(10) Pub. No.: US 2005/0125758 A1
(43) Pub. Date: Jun. 9, 2005

(54) Positioning of inverting buffers in a netlist

(75) Inventors: Robert Francis Lembach, Rochester, MN (US); Cory James Wood, Oronoco, MN (US)

Correspondence Address: Robert R. Williams;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/728,289

(22) Filed: Dec. 4, 2003

(51) Int. Cl. G06F 17/50

(52) U.S. Cl. 716/10; 716/2; 716/13

(57) ABSTRACT

A method, apparatus, system, and signal-bearing medium that, in an embodiment, position inverting buffers to improve placement of a logic circuit. An inverting buffer, within a netlist, is moved from a source region to a sink region, where the source region and the sink region are connected via inverting and non-inverting routes. Moving the inverting buffer eliminates one of the routes from the source region to the sink region. In this way, routing congestion and total wire length may be reduced.

### FIELD

The present invention pertains to the field of circuit design tools and more particularly to positioning of inverting buffers in a netlist.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs.

Automated design of integrated circuits and programming of either programmable logic devices or programmable gate arrays require specification of a logic circuit by a designer. A hardware description language (“HDL”) provides the designer with a mechanism for describing the operation of the desired logic circuit in a technology-independent manner.

There are two basic techniques for physically designing digital integrated circuits (or chips). These are commonly known as the full-custom technique and the standard-cell technique. In the full-custom technique, small blocks (or cells) are manually laid out by hand, one rectangle or polygon at a time to build first transistors, then logic gates, and then more complex circuits. A “block” is a small portion of a design that is designed and/or laid out separately. The cells are assembled together into larger groups (or blocks), which are themselves assembled into still larger blocks until a complete integrated circuit is created. For complex chip designs, this layout and assembly process requires large numbers of highly skilled designers and a long period of time.

The standard-cell technique for designing chips is a much simpler process and has gained wide use. Physical layouts and timing behavior models are created for simple logic functions such as AND, OR, NOT or FlipFlop. These physical layouts are known as “standard cells.” A large group of pre-designed standard cells is then assembled into a standard cell library, which is typically provided at a nominal cost by the fabrication vendor who will eventually produce the actual chip. Examples of these standard cell libraries are available from fabrication vendors such as TSMC or UMC. Automated software tools available from companies such as Cadence Design Systems and Synopsys can take a netlist description of the integrated circuit, or netlist representing the desired logical functionality for a chip (sometimes referred to as a behavioral or register-transfer-level description), and map it into an equivalent netlist composed of standard cells from a selected standard cell library. This process is commonly known as “synthesis.” A netlist is a data structure representation of the electronic logic system that comprises a set of modules, each of which comprises a data structure that specifies sub-components and their interconnection. The netlist describes the way standard cells and blocks are interconnected. Netlists are typically available in Verilog, EDIF (Electronic Design Interchange Format), or VHDL (Very High Speed Integrated Circuit Hardware Design Language) formats. Other software tools available from companies such as Cadence or Avant! can take a netlist comprised of standard cells and create a physical layout of the chip by placing the cells relative to each other to minimize timing delays or wire lengths, then creating electrical connections (or routing) between the cells to physically complete the desired circuit.

One common component of a circuit is an inverter, which is also called an inverting buffer. An inverting buffer is a single-input device that produces an output state opposite of the input. Thus, if the input to the inverting buffer is high, the output is low and vice versa. Current circuit design tools often place inverting buffers at sub-optimal locations in a logic network. A sub-optimal network topology complicates placement solutions and increases routing congestion and total wire length. Excessive wire length and routing congestion aggravates design closure issues, including timing closure and noise coupling between wires. There is also a potential cost impact due to the need for larger silicon die sizes in order to accommodate the additional routing. In the latest VLSI (Very Large Scale Integration) chip technologies, routing interconnect is a dominant factor in chip performance and cost. Also, the interconnect of non-inverting and inverting buffers is becoming increasingly important due to the large number of buffers being used.

Thus, without a better technique for locating inverting buffers, logic designs will continue to suffer from reduced performance and increased cost.

### SUMMARY

A method, apparatus, system, and signal-bearing medium are provided that, in an embodiment, position inverting buffers to improve placement of a logic circuit. An inverting buffer, within a netlist, is moved from a source region to a sink region, where the source region and the sink region are connected via inverting and non-inverting routes. Moving the inverting buffer eliminates one of the routes from the source region to the sink region. In this way, routing congestion and total wire length may be reduced.

### BRIEF DESCRIPTION OF THE DRAWINGS

FIG. 1 depicts a block diagram of an example system for implementing an embodiment of the invention.

FIG. 2A depicts a block diagram of an example floorplanned chip with multiple disjoint regions of logic circuits before preconditioning, according to an embodiment of the invention.

FIG. 2B depicts a block diagram of an example floorplanned chip with multiple disjoint regions of logic circuits after preconditioning, according to an embodiment of the invention.

FIG. 3A depicts a block diagram of an example chip without floorplans before preconditioning, according to an embodiment of the invention.

FIG. 3B depicts a block diagram of an example chip without floorplans after preconditioning, according to an embodiment of the invention.

FIG. 4 depicts a flowchart of example processing for a logic design tool, according to an embodiment of the invention.

FIG. 5 depicts a flowchart of example processing for a logic design tool, according to another embodiment of the invention.

### DETAILED DESCRIPTION

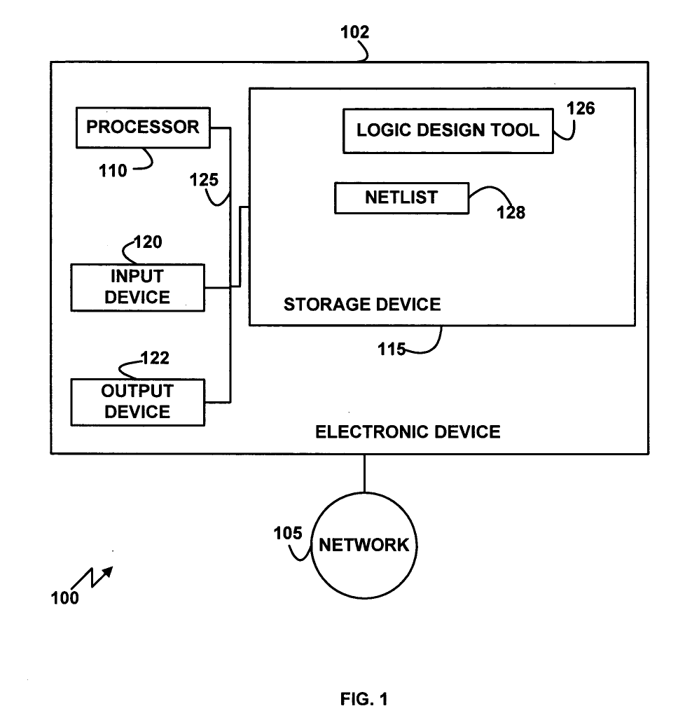

Referring to the Drawing, wherein like numbers denote like parts throughout the several views, FIG. 1 depicts a block diagram of an example system 100 for implementing an embodiment of the invention. The system 100 includes an electronic device 102 connected to a network 105. Although only one electronic device 102 and one network 105 are illustrated in FIG. 1, in other embodiments, any number of them may be present.

The electronic device 102 includes a processor 110, a storage device 115, an input device 120, and an output device 122, all connected directly or indirectly via a bus 125. The processor 110 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 110 executes instructions and includes that portion of the electronic device 102 that controls the operation of the entire electronic device. Although not depicted in FIG. 1, the processor 110 typically includes a control unit that organizes data and program storage in memory and transfers data and other information between the various parts of the electronic device 102. The processor 110 reads and/or writes code and data to/from the storage device 115, the network 105, the input device 120, and/or the output device 122. Although the electronic device 102 is drawn to contain only a single processor 110 and a single bus 125, embodiments of the present invention apply equally to electronic devices that may have multiple processors and multiple buses with some or all performing different functions in different ways.

The storage device 115 represents one or more mechanisms for storing data. For example, the storage device 115 may include read only memory (ROM), random access memory (RAM), magnetic disk storage media, optical storage media, flash memory devices, and/or other machine-readable media. In other embodiments, any appropriate type of storage device may be used. Although only one storage device 115 is shown, multiple storage devices and multiple types of storage devices may be present. Although the storage device 115 is shown in FIG. 1 as a single monolithic entity, the storage device 115 may in fact be distributed and/or hierarchical, as is known in the art. For example, the storage device 115 may exist in multiple levels of storage devices, and these levels of storage devices may be further divided by function, so that one level of storage device holds, e.g., instructions, while another holds, e.g., non-instruction data which is used by the processor or processors. The storage device 115 may further be distributed and associated with different processors or sets of processors, as is known in any of various so-called non-uniform memory access (NUMA) computer architectures. Further, although the electronic device 102 is drawn to contain the storage device 115, it may be distributed across other electronic devices, such as electronic devices connected to the network 105.

The storage device 115 includes a logic design tool 126 and a netlist 128, both of which may, in various embodiments, exist in any number. Although the logic design tool 126 and the netlist 128 are both illustrated as being contained within the storage device 115 in the electronic device 102, in other embodiments, some or all of them may be on different electronic devices and may be accessed remotely, e.g., via the network 105. The electronic device 102 may use virtual addressing mechanisms that allow the programs of the electronic device 102 to behave as if they only have access to a large, single storage entity instead of access to multiple, smaller storage entities. Thus, while the logic design tool 126 and the netlist 128 are illustrated as residing in the storage device 115, these elements are not necessarily all completely contained in the same storage device at the same time.

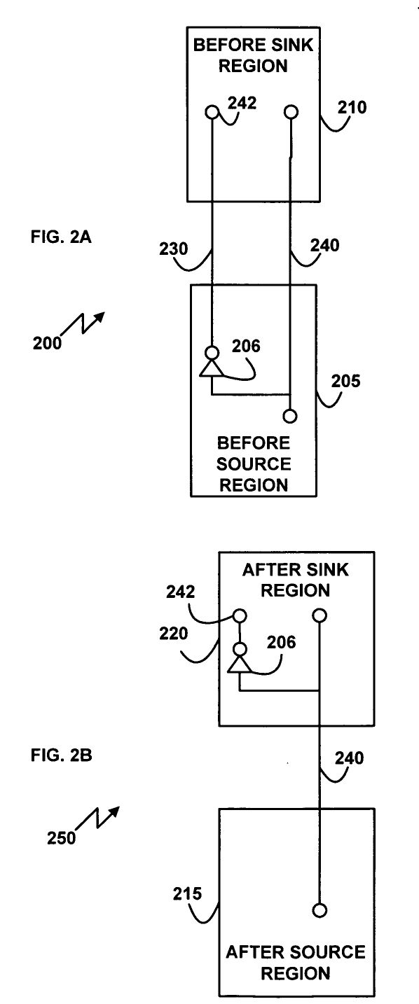

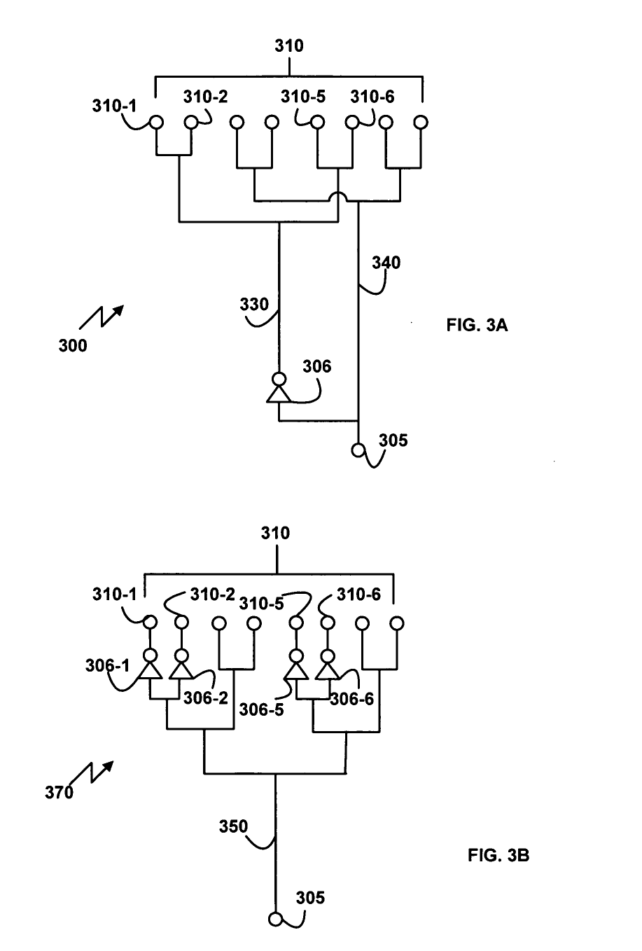

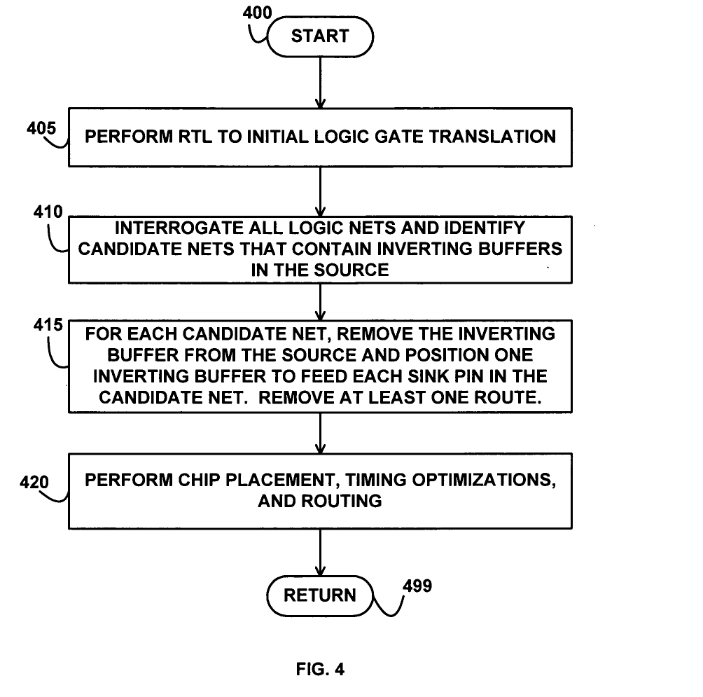

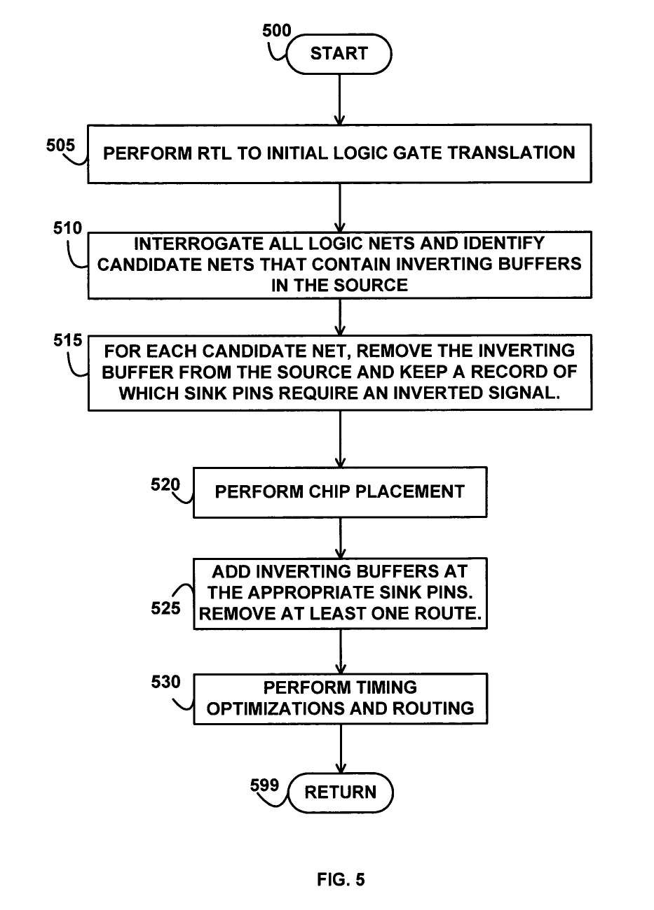

The logic design tool 126 performs preconditioning of the netlist 128 to provide a better placement of inverting buffers. The logic design tool 126 includes instructions capable of executing on the processor 110 or statements capable of being interpreted by instructions executing on the processor 110 to perform the functions as illustrated in FIGS. 2A, 2B, 3A, and 3B, and as further described below with reference to FIGS. 4 and 5. In another embodiment, the logic design tool 126 may be implemented in hardware in lieu of or in addition to a processor-based system.

The netlist 128 is a data structure representation of an electronic logic system that includes a set of modules, each of which includes a data structure that specifies sub-components and their interconnection. The netlist describes the way standard cells and blocks are interconnected. Netlists are typically available in Verilog, EDIF (Electronic Design Interchange Format), or VHDL (Very High Speed Integrated Circuit Hardware Design Language) formats, but in other embodiments any appropriate format may be used.

The input device 120 may be a keyboard, mouse or other pointing device, trackball, touchpad, touchscreen, keypad, microphone, voice recognition device, or any other appropriate mechanism for the user to input data to the electronic device 102 and/or to manipulate the user interfaces of the electronic device 102. Although only one input device 120 is shown, in another embodiment any number and type of input devices may be present.

The output device 122 is that part of the electronic device 102 that presents output to the user. The output device 122 may be a cathode-ray tube (CRT) based video display well known in the art of computer hardware. But, in other embodiments the output device 122 may be replaced with a liquid crystal display (LCD) based or gas, plasma-based, flat-panel display. In still other embodiments, any appropriate display device may be used. In other embodiments, a speaker or a printer may be used. In other embodiments any appropriate output device may be used. Although only one output device 122 is shown, in other embodiments, any number of output devices of different types or of the same type may be present.

The bus 125 may represent one or more busses, e.g., PCI (Peripheral Component Interconnect), ISA (Industry Standard Architecture), X-Bus, EISA (Extended Industry Standard Architecture), or any other appropriate bus and/or bridge (also called a bus controller). Although the bus 125 is shown in FIG. 1 as a relatively simple, single bus structure providing a direct communication path among the processor 110, the storage device 115, the input device 120, and the output device 122, in other embodiments the bus 125 may comprise multiple different buses or communication paths, which may be arranged in any of various forms, such as point-to-point links in hierarchical, star or web configurations, multiple hierarchical buses, or parallel and redundant paths. Furthermore, while the bus 125 is shown directly connected to the processor 110, the storage device 115, the input device 120, and the output device 122, in other embodiments, some or all of the I/O (Input/Output) devices may be connected via I/O processors.

The network 105 may be any suitable network or combination of networks and may support any appropriate protocol suitable for communication of data and/or code to/from the electronic device 102. In various embodiments, the network 105 may represent a storage device or a combination of storage devices, either connected directly or indirectly to the electronic device 102. In an embodiment, the network 105 may support Infiniband. In another embodiment, the network 105 may support wireless communications. In another embodiment, the network 105 may support hard-wired communications, such as a telephone line or cable. In another embodiment, the network 105 may support the Ethernet IEEE (Institute of Electrical and Electronics Engineers) 802.3x specification. In another embodiment, the network 105 may be the Internet and may support IP (Internet Protocol). In another embodiment, the network 105 may be a local area network (LAN) or a wide area network (WAN). In another embodiment, the network 105 may be a hotspot service provider network. In another embodiment, the network 105 may be an intranet. In another embodiment, the network 105 may be a GPRS (General Packet Radio Service) network. In another embodiment, the network 105 may be a FRS (Family Radio Service) network. In another embodiment, the network 105 may be any appropriate cellular data network or cell-based radio network technology. In another embodiment, the network 105 may be an IEEE 802.11B wireless network. In still another embodiment, the network 105 may be any suitable network or combination of networks. Although one network 105 is shown, in other embodiments any number of networks (of the same or different types) may be present.

The electronic device 102 may be implemented using any suitable hardware and/or software, such as a personal computer. Portable computers, laptop or notebook computers, PDAs (Personal Digital Assistants), pocket computers, and mainframe computers are examples of other possible configurations. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the electronic device 102, and that, when read and executed by one or more processors in the electronic device 102, cause the electronic device 102 to perform the steps necessary to execute steps or elements embodying the various aspects of an embodiment of the invention.

Moreover, while embodiments of the invention have thus far, and hereinafter, will be described in the context of fully functioning electronic devices, the various embodiments of the invention are capable of being distributed as a program product in a variety of forms, and the invention applies equally regardless of the particular type of signal-bearing medium used to actually carry out the distribution. The programs defining the functions of this embodiment may be delivered to the electronic device 102 via a variety of signal-bearing media, which include, but are not limited to:
(1) information permanently stored on a non-rewriteable storage medium, e.g., a read-only memory device attached to or within an electronic device, such as a CD-ROM readable by a CD-ROM drive;
(2) alterable information stored on a rewriteable storage medium, e.g., a hard disk drive or diskette; or
(3) information conveyed to an electronic device by a communications medium, such as through a computer or a telephone network, e.g., the network 105, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2A depicts a block diagram of an example floorplanned chip 200 with multiple disjoint regions of logic circuits before preconditioning by the logic design tool 126, according to an embodiment of the invention. Before preconditioning, the before source region 205 includes an inverting buffer 206. Thus, two routes 230 and 240 are required between the before source region 205 and the before sink region 210 since both inverting and non-inverting signals are sent from the before source region 205 to the before sink region 210. The before sink region 210 includes a sink pin 242, which receives the inverted signal from the inverting buffer 206 via the route 230. Although only one sink pin 242 is shown, in other embodiments any number of sink pins receiving the inverted signal from the inverting buffer 206 may be present. The chip 200 is exemplary only, and in other embodiments any appropriate chip that includes at least one inverting buffer, at least one source region, and at least one sink region may be used.

The following example EDIF statements in the netlist 128 illustrate the design of the example floorplanned chip 200 illustrated in FIG. 2A before preconditioning:

(edif FP_BEFORE

(library basic

(cell INVERTER (cellType GENERIC)

(view symbol (viewType NETLIST)

(interface
(port A (direction INPUT))
(port Z (direction OUTPUT))

)

)

)

)
(library fp_before

(cell FP_BEFORE (cellType GENERIC)

(view schematic (viewType NETLIST)

(interface

(port SOURCE (direction INPUT))
(port SINK_1 (direction OUTPUT))
(port SINK_2 (direction OUTPUT))

)
(contents

(instance INVERTER_AT_SOURCE

(viewRef symbol (cellRef INVERTER
(libraryRef basic)))

)
(net NON_INVERTED

(joined

(portRef SOURCE)
(portRef SINK_2)
(portRef A (instanceRef
INVERTER_AT_SOURCE))

)

)
(net INVERTED

(joined

(portRef SINK_1)
(portRef Z (instanceRef
INVERTER_AT_SOURCE))
)

)

)

)

)

)

)

FIG. 2B depicts a block diagram of an example floorplanned chip 250 with multiple disjoint regions of logic circuits after preconditioning by the logic design tool 126, according to an embodiment of the invention. After preconditioning by the logic design tool 126, the logic design tool 126 has moved the inverting buffer 206 from the before source region 205 (FIG. 2A) to the after sink region 220, so that the after source region 215 no longer contains the inverting buffer 206. The inverting buffer 206 is now associated with the sink pin 242. Notice that before preconditioning (FIG. 2A), two routes 230 and 240 are required between the source region 205 and the sink region 210, but after preconditioning (FIG. 2B), the logic design tool 126 has removed the route 230 (FIG. 2A). Only the one route 240 is required between the after source region 215 and the after sink region 220. Thus, in this simple example, one region-to-region route (230) is eliminated. In a more complex example, if a signal is a wide bus of 1024 bits, 1024 routes may be eliminated. Thus, the wiring demand for a signal is essentially half following the preconditioning by the logic design tool 126.

The following example EDIF statements in the netlist 128 illustrate the design of the example floorplanned chip 250 illustrated in FIG. 2B after preconditioning:

(edif FP_AFTER

(library basic

(cell INVERTER (cellType GENERIC)

(view symbol (viewType NETLIST)

(interface

(port A (direction INPUT))
(port Z (direction OUTPUT))

)

)

)

)
(library fp_after

(cell FP_AFTER (cellType GENERIC)

(view schematic (viewType NETLIST)

(interface

(port SOURCE (direction INPUT))
(port SINK_1 (direction OUTPUT))
(port SINK_2 (direction OUTPUT))

)
(contents

(instance INVERTER_AT_SINK

(viewRef symbol (cellRef INVERTER
(libraryRef basic)))

)
(net NON_INVERTED

(joined

(portRef SOURCE)
(portRef SINK_2)
(portRef A (instanceRef
INVERTER_AT_SINK))

)

)
(net INVERTED

(joined

(portRef SINK_1)
(portRef Z (instanceRef
INVERTER_AT_SINK))

)

)

)

)

)

)

)

FIG. 3A depicts a block diagram of an example chip 300 without floorplans before preconditioning, according to an embodiment of the invention. Typically, a large proportion of logic nets on a chip lie within the chip subpartitions. These nets have their source pin (such as source pin 305) and all sink pins (such as sink pins 310) within the same floorplan region, or subpartition. Addressing the sub-optimal buffering in these nets leads to a significant reduction in wiring demand within the subpartition, as well as across the entire chip.

Before preconditioning, the source pin 305 is associated with an inverting buffer 306. Inverting signals travel from the inverting buffer 306 to the sink pins 310-1, 310-2, 310-5, and 310-6 via the route 330. Non-inverting signals travel from the source pin 305 through the route 340 to the remaining pins. Thus, two routes 330 and 340 are required between the source pin 305 and the sink pins 310 since both inverting and non-inverting signals are sent from the source pin 305 to the sink pins 310.

The following example EDIF statements in the netlist 128 illustrate the design of the example chip 300 without floor plans illustrated in FIG. 3A before preconditioning by the logic design tool 126:

(edif NOFP_BEFORE

(library basic

(cell INVERTER (cellType GENERIC)

(view symbol (viewType NETLIST)

(interface

(port A (direction INPUT))
(port Z (direction OUTPUT))

)

)

)

)
(library nofp_before

(cell NOFP_BEFORE (cellType GENERIC)

(view schematic (viewType NETLIST)

(interface

(port SOURCE (direction INPUT))
(port SINK_1 (direction OUTPUT))
(port SINK_2 (direction OUTPUT))
(port SINK_3 (direction OUTPUT))
(port SINK_4 (direction OUTPUT))
(port SINK_5 (direction OUTPUT))
(port SINK_6 (direction OUTPUT))
(port SINK_7 (direction OUTPUT))
(port SINK_8 (direction OUTPUT))

)
(contents

(instance INVERTER_1

(viewRef symbol (cellRef
INVERTER (libraryRef basic)))

)
(net NON_INVERTED

(joined

(portRef SOURCE)
(portRef SINK_3)
(portRef SINK_4)
(portRef SINK_7)
(portRef SINK_8)
(portRef A (instanceRef
INVERTER_1))

)

)
(net INVERTED

(joined

(portRef SINK_1)
(portRef SINK_2)
(portRef SINK_5)
(portRef SINK_6)
(portRef Z (instanceRef
INVERTER_1))

)

)

)

)

)

)

)

FIG. 3B depicts a block diagram of an example chip 370 without floorplans after preconditioning by the logic design tool 126, according to an embodiment of the invention. After preconditioning by the logic design tool 126, the logic design tool 126 has replaced the inverting buffer 306 associated with the source pin 305 with the four inverting buffers 306-1, 306-2, 306-5, and 306-6 associated with respective sink pins 310-1, 310-2, 310-5, and 310-6. Notice that before preconditioning (FIG. 3A), two routes 330 and 340 are required between the source pin 305 and the sink pins 310, but after preconditioning by the logic design tool 126, only the one route 350 is required between the source pin 305 and the sink pins 310. Thus, in this simple example, the logic design tool 126 has eliminated one route. In more complicated examples, the logic design tool 126 may eliminate far more routes. The wiring demand for a signal is essentially half following the preconditioning performed by the logic design tool 126.

The following example EDIF statements in the netlist 128 illustrate the design of the example chip 370 without floor plans illustrated in FIG. 3B after the preconditioning by the logic design tool 126:

(edif NOFP_AFTER

(library basic

(cell INVERTER (cellType GENERIC)

(view symbol (viewType NETLIST)

(interface

(port A (direction INPUT))
(port Z (direction OUTPUT))

)

)

)

)
(library nofp_after

(cell NOFP_AFTER (cellType GENERIC)

(view schematic (viewType NETLIST)

(interface

(port SOURCE (direction INPUT))
(port SINK_1 (direction OUTPUT))
(port SINK_2 (direction OUTPUT))
(port SINK_3 (direction OUTPUT))
(port SINK_4 (direction OUTPUT))
(port SINK_5 (direction OUTPUT))
(port SINK_6 (direction OUTPUT))
(port SINK_7 (direction OUTPUT))
(port SINK_8 (direction OUTPUT))

)
(contents

(instance INVERTER_1

(viewRef symbol (cellRef
INVERTER (libraryRef basic)))

)
(instance INVERTER_2

(viewRef symbol (cellRef
INVERTER (libraryRef basic)))

)
(instance INVERTER_3

(viewRef symbol (cellRef
INVERTER (libraryRef basic)))

)
(instance INVERTER_4

(viewRef symbol (cellRef
INVERTER (libraryRef basic)))

)
(net NON_INVERTED

(joined

(portRef SOURCE)
(portRef SINK_3)
(portRef SINK_4)
(portRef SINK_7)
(portRef SINK_8)
(portRef A (instanceRef
INVERTER_1))
(portRef A (instanceRef
INVERTER_2))
(portRef A (instanceRef
INVERTER_3))
(portRef A (instanceRef
INVERTER_4))

)

)
(net INVERTED_1

(joined

(portRef SINK_1)
(portRef Z (instanceRef
INVERTER_1))

)

)
(net INVERTED_2

(joined

(portRef SINK_2)
(portRef Z (instanceRef
INVERTER_2))

)

)
(net INVERTED_3

(joined

(portRef SINK_5)
(portRef Z (instanceRef
INVERTER_3))

)

)
(net INVERTED_4

(joined

(portRef SINK_6)
(portRef Z (instanceRef
INVERTER_4))

)

)

)

)

)

)

)

FIG. 4 depicts a flowchart of example processing for the logic design tool 126, according to an embodiment of the invention. Control begins at block 400. Control then continues to block 405 where the logic design tool 126 performs initial RTL (register transfer language) to logic gate translation on the netlist 128.

Control then continues to block 410 where the logic design tool 126 interrogates all logic nets in the netlist 128 and identifies candidate nets that contain inverting buffers associated with a source (e.g., the inverting buffer 206 in the before source region 205 in FIG. 2A or the inverting buffer 306 associated with the source node 305 in FIG. 3A).

Control then continues to block 415 where the logic design tool 126, for each candidate net, removes the inverting buffer from the source and positions one inverting buffer to feed each sink pin in the candidate net, e.g., the sink pin 242 in FIG. 2B or the sink pins 310-1, 310-2, 310-5, and 310-6 in FIG. 3B. The logic design tool 126 further removes at least one route between the source and the sink in response to the removing of the inverting buffer from the source and the adding the inverting buffer at the sink.

Control then continues to block 420 where the logic design tool 126 performs chip placement, timing optimizations, and routing. Control then continues to block 499 where the logic of FIG. 4 returns.

In another embodiment, the logic of block 415 may be performed subsequent to chip placement and timing optimization. Such an embodiment will probably not yield as good a solution as that described in FIG. 4 since chip placement is run with the sub-optimal connectivity, but this embodiment still mitigates routing congestion.

Although the logic design tool 126 has been described as performing all of the RTL to logic gate translation, preconditioning, chip placement, timing optimization, and routing, in other embodiments, some or all of these functions may be performed by separate design tools.

FIG. 5 depicts a flowchart of example processing for the logic design tool 126, according to another embodiment of the invention. Control begins at block 500. Control then continues to block 505, where the logic design tool 126 performs initial RTL (register transfer language) to logic gate translation on the netlist 128.

Control then continues to block 510 where the logic design tool 126 interrogates all logic nets in the netlist 128 and identifies candidate nets that contain inverting buffers associated with a source (e.g., the inverting buffer 206 in the before source region 205 in FIG. 2A or the inverting buffer 306 associated with the source node 305 in FIG. 3A).

Control then continues to block 515 where the logic design tool 126, for each candidate net, removes the inverting buffer from the source and keeps a record of which sink pins require an inverted signal. Control then continues to block 520 where the logic design tool 126 performs chip placement operations.

Control then continues to block 525 where the logic design tool 126 adds inverting buffers at the sink pins that were previously recorded above with reference to block 515. The logic design tool 126 further removes at least one route between the source and the sink in response to the removing of the inverting buffer from the source and the adding the inverting buffer at the sink.

Control then continues to block 530 where the logic design tool 126 performs timing optimizations and routing. Control then continues to block 599 where the logic of FIG. 5 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

1. A method comprising:
moving an inverting buffer from a source to a sink in a netlist if both inverting and non-inverting signals are to be sent from the source to the sink.

2. The method of claim 1, wherein the moving further comprises:
finding the inverting buffer associated with the source in the netlist;
removing the inverting buffer associated with the source; and
adding the inverting buffer to the sink, wherein the sink is connected to the source via a plurality of routes.

3. The method of claim 2, wherein at least a first route of the plurality of routes is to send the inverting signals and at least a second route of the plurality of routes is to send the non-inverting signals.

4. The method of claim 3, further comprising:
removing the first route.

5. The method of claim 2, wherein the adding is performed prior to chip placement, timing optimizations, and routing.

6. The method of claim 2, wherein the adding is performed after chip placement and before timing optimizations and routing.

7. An apparatus comprising:
means for finding an inverting buffer associated with a source in a netlist;
means for removing the inverting buffer associated with the source; and
means for adding the inverting buffer to a sink, wherein the sink is connected to the source via a plurality of routes, and wherein at least a first route of the plurality of routes is to send inverting signals and at least a second route of the plurality of routes is to send non-inverting signals.

8. The apparatus of claim 7, further comprising:
means for removing the first route.

9. The apparatus of claim 7, wherein the means for adding is performed prior to chip placement, timing optimizations, and routing.

10. The apparatus of claim 7, wherein the means for adding is performed after chip placement and before timing optimizations and routing.

11. A signal-bearing medium encoded with instructions, wherein the instructions when executed comprise:
finding an inverting buffer associated with a source in a netlist;
removing the inverting buffer associated with the source;
adding the inverting buffer to a sink, wherein the sink is connected to the source via a plurality of routes; and
removing at least one of the plurality of routes.

12. The signal-bearing medium of claim 11, wherein the adding is performed prior to chip placement, timing optimizations, and routing.

13. The signal-bearing medium of claim 11, wherein the adding is performed after chip placement and before timing optimizations and routing.

14. The signal-bearing medium of claim 11, wherein the source represents a source region in a floorplanned chip and the sink represents a sink region in the floorplanned chip.

15. The signal-bearing medium of claim 11, wherein the source and sink are in a chip without floorplans.

16. The signal-bearing medium of claim 11, wherein the source and sink are in a same subpartition of a chip.

17. An electronic device comprising:
a processor; and
a storage device encoded with instructions, wherein the instructions when executed on the processor comprise:
finding an inverting buffer associated with a source in a netlist,
removing the inverting buffer associated with the source,
adding the inverting buffer to a sink, wherein the sink is connected to the source via a plurality of routes, and wherein at least a first route of the plurality of routes is to send inverting signals and at least a second route of the plurality of routes is to send non-inverting signals, and
removing the first route.

18. The electronic device of claim 16, wherein the source represents a source region in a floorplanned chip and the sink represents a sink region in the floorplanned chip.

19. The electronic device of claim 16, wherein the source and sink are in a chip without floorplans.

20. The electronic device of claim 16, wherein the source and sink are in a same subpartition of a chip.
